(19) United States
(12) Patent Application Publication
(10) Pub. No.: US 2009/0088030 A1
(43) Pub. Date: Apr. 2, 2009

(54) CONDUCTOR TERMINAL

(76) Inventors: Konrad STROMIEDEL, Wolkramshausen (DE); Thomas Truemper, Breitenbach (DE)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/239,907

(22) Filed: Sep. 29, 2008

(30) Foreign Application Priority Data
Oct. 1, 2007 (DE) 20 2007 014 596.9

(51) Int. Cl. H01R 4/48

(52) U.S. Cl. 439/729

(57) ABSTRACT

A description is given of a conductor terminal (1) having an insulating-material housing (2) and at least one leaf-spring contact (3) which is installed in the insulating-material housing (2) and has a carrying frame (8) and a leaf-spring tab (9) which projects from the carrying frame into an associated conductor-introduction opening (4) formed in the insulating-material housing (2). On that side of the insulating-material housing (2) which is located opposite the inlet into the conductor-introduction opening (4), an overload-protection web (11), which is formed integrally with the insulating-material housing (2), projects into the spring region of the leaf-spring tab (9) and is arranged between the carrying frame and the leaf-spring tab (9) such that, when the leaf-spring tab (9) is deflected to the maximum admissible extent, defined by the overload-protection web (11), in the direction of the carrying frame (8), the end of the leaf-spring tab (9) rests on the overload-protection web (11).

The invention relates to a conductor terminal having an insulating-material housing and at least one leaf-spring contact which is installed in the insulating-material housing and has a carrying frame and a leaf-spring tab which projects from the carrying frame into an associated conductor-introduction opening formed in the insulating-material housing.

Conductor terminals having an insulating-material housing and spring contacts installed therein are available in a very wide range of forms. The leaf-spring contacts are preferably produced in a single piece, but may also be formed in two parts from a clamping spring fitted on a conductor rail.

DE 203 03 537 U1 discloses a conductor terminal in which clamping springs are formed from tabs which are cut out of a carrier element. The tabs project into the concave interior of an insulating-material housing and, when a conductor is introduced, are bent in the direction of the concave inner wall.

DE 10 2004 030 085 A1 discloses a conductor terminal in which a piece of spring-steel sheet is used as a carrier plate for a conductor-rail component and this carrier plate and the spring-steel sheet from which the leaf-spring tab is cut out, are connected such that the two spring-steel sheets, in part, execute, with elastically resilient action, the necessary opening displacement for the clamping site when an electric conductor is connected. Here too, the leaf-spring tab can be deflected without limitation as far as the opposite inner wall of the insulating-material housing.

In addition to those forms of leaf-spring contact which are mentioned above, there are also those in which, rather than the restoring force of the leaf-spring tabs being generated by the leaf-spring tab being moved away from its carrying frame as an electric conductor is plugged into the respective conductor-clamping site, the reverse is the case; in other words, the leaf-spring tab is moved toward its carrying frame when an electric conductor is plugged into the respective conductor-clamping site. Such an embodiment is described in U.S. Pat. No. 4,673,232.

Taking this as the departure point, the object of the present invention is to provide an improved conductor terminal which, while ensuring inexpensive and straightforward assembly, protects the leaf-spring tab against overloading.

The object is achieved by the conductor terminal of the type mentioned in the introduction in that, on that side of the insulating-material housing which is located opposite the inlet into the conductor-introduction opening, an overload-protection web, which is formed integrally with the insulating-material housing, projects into the spring region of the leaf spring and is arranged between the carrying frame and the leaf-spring tab such that, when the leaf-spring tab is deflected to the maximum admissible extent, defined by the overload-protection web, in the direction of the carrying frame, the end of the leaf-spring tab rests on the overload-protection web.

It is thus proposed to integrate in the insulating-material housing an overload web which limits the deflection capability of the leaf-spring tab to an admissible level.

In order to avoid excessive deflection of the leaf-spring tab, and therefore overloading of the same, a preferred embodiment provides, on that side of the insulating-material housing which is located opposite the inlet into the conductor-introduction opening, an overload-protection web, which is formed integrally with the insulating-material housing, projects into the spring region and is arranged between the carrying frame and the leaf-spring tab such that, when the leaf-spring tab is deflected to the maximum admissible extent, defined by the overload-protection web, in the direction of the carrying frame, the end of the leaf-spring tab rests on the overload-protection web.

This at least one overload-protection web is formed, for example, on a rear-side closure cover which is formed integrally on the insulating-material housing for pivoting action by way of a film hinge. Upon assembly of the conductor terminal, it is therefore possible for the leaf-spring contacts to be pushed into the insulating-material housing from the rear side of the latter, the rear side being accessible through the open rear-side closure cover. The rear-side closure cover is then swung closed and locked, in which case the overload-protection webs, which are formed integrally on the inside of the rear-side closure cover, project into the interior of the insulating-material housing such that the overload-protection webs are located between the leaf-spring contacts and the carrying frame of the leaf-spring contacts.

It is also conceivable, however, for the insulating-material housing, rather than having any swing-open installation openings, to be in a single piece closed all the way round. In the case of such an embodiment, it is possible for the at least one overload-protection web, in turn, to be formed integrally on the inside of the rear-side wall of the insulating-material housing, which is in a single piece closed all the way round, and to project into the conductor-introduction opening. Provided beneath a conductor-introduction opening, then, in each case is an associated guide channel which is intended for accommodating and guiding a leaf-spring contact and has a stop which is positioned such that, when the leaf-spring contact pushed into the guide channel is fitted, the leaf-spring tab can be pivoted past the overload-protection web into the conductor-introduction opening and, when the leaf-spring contact is subsequently displaced away from the stop, the end of the leaf-spring tab rests on the overload-protection web with the leaf-spring tab deflected. During assembly, the leaf-spring tab is thus drawn through beneath the overload-protection web and briefly deflected to a more pronounced extent than is permitted by the overload-protection web in the assembled state. Once the leaf-spring tab has been guided past the overload-protection web and has sprung into the conductor-introduction opening, the leaf-spring tab is displaced back again to a small extent, in which case the overload-protection web can take effect.

If, as is the case for example in the embodiment described, in each case one associated guide channel for accommodating a leaf-spring contact is provided in the insulating-material housing, beneath a conductor-introduction opening, the at least one leaf-spring contact can be wedged in the guide channel by virtue of the insulating-material housing being deformed. The leaf-spring contact is thus secured relative to the insulating-material housing.

If the rear-side closure cover is formed integrally on the insulating-material housing by way of a film hinge, this gives rise to the problem, during assembly, that the bottom edge of the rear-side closure cover has to be positioned in a correctly fitting manner on the base of the insulating-material housing. The flexibility of the film hinge may mean that the bottom edge of the rear-side closure cover projects too far downward. In order to prevent this, and to allow straightforward quick automatic or manual production, at least one bending post, which is oriented in the direction of the film hinge, is formed integrally on the rear-side wall of the insulating-material housing adjacent to the film hinge. The bending post is designed such that, when the rear-side closure cover is closed, disadvantageous deflection of the film hinge is prevented and the bottom edge of the rear-side closure cover is thus guided in a correctly fitting manner into the locking position with the base of the insulating-material housing.

In a particularly preferred embodiment, the at least one leaf-spring contact accommodated in the insulating-material housing is formed integrally from a sheet-metal material, the sheet-metal material consisting of a spring-material alloy which is plated, on at least a top side, with a conductive sheet-metal material made of an electrically conductive conductor material with current-carrying capacity. The at least one solder lug may be tin-plated.

The leaf-spring contact may be bent, for example, in an L-shaped or U-shaped manner such that the spring region with the carrying frame extends transversely to the solder lug. If there is only one solder lug provided at one end of the sheet-metal material, the leaf-spring contact is preferably bent in an L-shaped manner. If there are solder lugs at both ends of the sheet-metal material, these solder lugs are preferably bent away from the spring region in the same direction and extend parallel to one another. The leaf-spring contact is then of U-shaped configuration.

The invention will be described in more detail hereinbelow by way of exemplary embodiment and with reference to the accompanying drawings, in which:

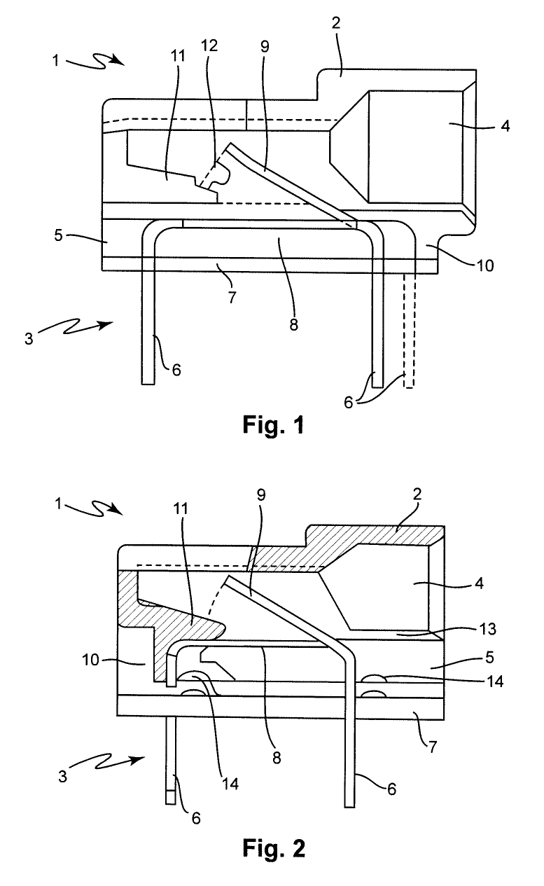

FIG. 1 shows a sectional view from the side of an insulating-material housing which is closed on one side and has a leaf-spring contact which can be pushed in from the rear side;

FIG. 2 shows a sectional view from the side of an insulating-material housing which is in a single piece closed all the way round and has a leaf-spring contact which can be pushed in from the front side;

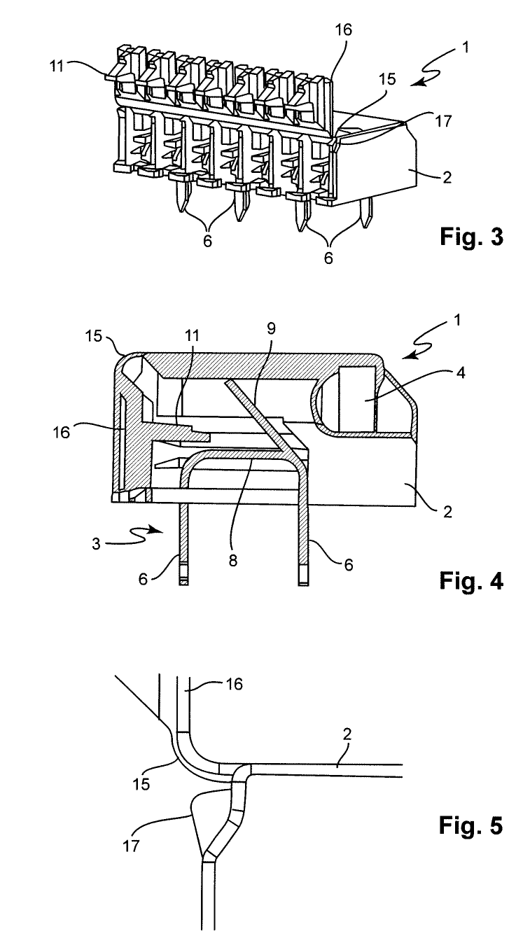

FIG. 3 shows a perspective view of a conductor terminal from the rear side with a rear-side closure cover open;

FIG. 4 shows a side view of the conductor terminal from FIG. 1 with the rear-side closure cover closed; and

FIG. 5 shows a view of part of the conductor terminal from FIGS. 3 and 4 with the rear-side closure cover open, in the region of the film hinge.

### DESCRIPTION OF THE PREFERRED EMBODIMENT

FIG. 1 shows a sectional view from the side of a particular embodiment of a conductor terminal 1 in which the insulating-material housing 2 is configured in a single piece without any installation flaps for the installation of a leaf-spring contact 3. Provided beneath the conductor-introduction opening 4, which is open on the front side of the insulating-material housing 2, is a guide channel 5 which is adapted to the leaf-spring contact 3 such that the latter is retained in the guide channel 5 and solder lugs 6 project out of the base 7 of the insulating-material housing 2, the base bounding the guide channel 5, and the leaf-spring contact 3 is retained in the guide channel 5 in the process. For the purpose of assembling the conductor terminal 1, the leaf-spring contact 3 is pushed into the guide channel 5 from the rear side, a leaf-spring tab 9, which projects from a carrying frame 8 of the leaf-spring contact 3, being deflected to a pronounced extent. When the leaf-spring contact 3 reaches a stop 10 provided in the front region of the guide channel 5, the leaf-spring tab 9 no longer butts against an overload-protection web 11, which projects into the conductor-introduction opening 4 from the rear side, and it springs upward into the conductor-introduction opening 4. In order to prevent excessive deflection of the leaf-spring tab 9, the leaf-spring contact 3 is displaced away from the stop again (out of the dashed position) to the extent where, when the leaf-spring tab 9 is deflected, the end of the leaf-spring tab 9 rests on the overload-protection web 11, preferably in a hollow 12 made thereon. The leaf-spring contact 3 can then be wedged by virtue of the insulating-material housing 2 being deformed, i.e. it can be secured on the insulating-material housing 2.

FIG. 2 shows another embodiment of a conductor terminal 1, this time with the guide channel 5 being accessible from the front side of the insulating-material housing 2. The stop 10 is formed on the rear side beneath the overload-protection web 11. When the leaf spring 3 is pushed into the insulating-material housing 2, the leaf-spring tab 9 is initially deflected to the extent where it is moved past beneath the bottom wall 13 of the conductor-introduction opening 4 until a cutout made in the conductor-introduction opening 4 of the insulating-material housing 2 allows it to spring into the conductor-introduction opening 4. The leaf spring 3 is then displaced as far as the stop 10 and possibly wedged with the insulating-material housing 2 and secured on the latter by material protrusions 14 which have been formed therefrom.

FIG. 3 shows a further variant of a conductor terminal 1, in the case of which the rear side of the insulating-material housing 2 can be closed with the aid of a rear-side closure cover 16 which is articulated on the insulating-material housing 2 by way of a film hinge 15. During assembly, the leaf-spring contact 3 can be pushed into the guide channel 5 from the rear side and retained in the insulating-material housing 2 by the rear-side closure cover 16, which is then swung down and locked to the base of the insulating-material housing 2. An overload-protection web 11 is integrally formed, for a respective leaf-spring contact 3, on the inside of the rear-side closure cover 16 and, once the rear-side closure cover 16 has been closed, is located between a longitudinal frame carrier of the leaf-spring contact 3 and the leaf-spring tab 9 in the manner which is illustrated in FIGS. 1 and 2.

FIG. 4 shows a side view of the closed conductor terminal 1 from FIG. 1. As the rear-side closure cover 16 is swung closed, it has to be ensured that the bottom edge of the rear-side closure cover 16 is aligned correctly, in the closing position, with the rear-side edge of the base of the insulating-material housing 2 and does not project too far downward on account of disadvantageous curvature of the film hinge 15. At least one bending post 17, preferably one bending post 17 per leaf-spring contact 3, is preferably provided on the rear side of the insulating-material housing 2, and this bending post is arranged adjacent to the film hinge 15 and is oriented toward the film hinge 15 such that, when the film hinge 15 is deflected in a disadvantageous manner, it strikes against the bending post 17 and is deflected such that it is ensured that the bottom edge of the rear-side closure cover 16 is guided in a correctly fitting manner into the closing position.

1. Conductor terminal (1) having an insulating-material housing (2) and at least one leaf-spring contact (3) which is installed in the insulating-material housing (2) and has a carrying frame (8) and a leaf-spring tab (9) which projects from the carrying frame into an associated conductor-introduction opening (4) formed in the insulating-material housing (2), characterized in that, on that side of the insulating-material housing (2) which is located opposite the inlet into the conductor-introduction opening (4), an overload-protection web (11), which is formed integrally with the insulating-material housing (2), projects into the spring region of the leaf-spring tab (9) and is arranged between the carrying frame and the leaf-spring tab (9) such that, when the leaf-spring tab (9) is deflected to the maximum admissible extent, defined by the overload-protection web (11), in the direction of the carrying frame (8), the end of the leaf-spring tab (9) rests on the overload-protection web (11).

2. Conductor terminal (1) according to claim 1, characterized in that the at least one overload-protection web (11) is formed on a rear-side closure cover (16) which is formed integrally on the insulating-material housing (2) for pivoting action by way of a film hinge (15).

3. Conductor terminal (1) according to claim 2, characterized in that at least one bending post (17), which is oriented in the direction of the film hinge (15), is formed integrally on the rear-side wall adjacent to the film hinge (15) such that, when the rear-side closure cover (16) is closed, the at least one bending post (17) prevents the film hinge (15) from curving such that the bottom edge of the rear-side closure cover (16), this bottom edge being located opposite the film hinge (15), strikes against the rear-side edge of the base of the insulating-material housing (2).

4. Conductor terminal (1) according to claim 1, characterized in that the at least one overload-protection web (11) is formed integrally on the inside of the rear-side wall of the insulating-material housing (2), which is in a single piece closed all the way round, and it projects into the conductor-introduction opening (4), and in that provided beneath a conductor-introduction opening (4) in each case is an associated guide channel (5) which is intended for accommodating and guiding a leaf-spring contact (3) and has a stop (10) which is positioned such that, when the leaf-spring contact (3) pushed into the guide channel (5) is fitted, the leaf-spring tab (9) can be pivoted past the overload-protection web (11) into the conductor-introduction opening (4) and, when the leaf-spring contact (3) is subsequently displaced away from the stop, the end of the leaf-spring tab (9) rests on the overload-protection web (11) with the leaf-spring tab (9) deflected to the maximum extent.

5. Conductor terminal (1) according to claim 1, characterized in that in each case one associated guide channel (5) for accommodating a leaf-spring contact (3) is provided in the insulating-material housing (2), beneath a conductor-introduction opening (4), and the at least one leaf-spring contact (3) is wedged in the guide channel (5) by virtue of the insulating-material housing (2) being deformed.

6. Conductor terminal (1) according to claim 1, characterized in that the at least one leaf-spring contact (3) has a solder lug (6) which merges into a spring region of greater width than the width of the solder lug (6) and, in the spring region, the leaf-spring tab (9) is freed from the sheet-metal material such that the sheet-metal-material strips adjacent to the leaf-spring tab (9) form a carrying frame (8) which is intended for the leaf-spring tab (9) and has two side frame parts, running parallel to the longitudinal extent of the leaf-spring tab (9), and a transverse frame part which is connected integrally to the root of the leaf-spring tab (9), the leaf-spring tab (9) being bent out of the plane of the surface-area extent of the carrying frame (8).

7. Conductor terminal (1) according to claim 1, characterized in that the leaf-spring contact (3) is formed integrally from a sheet-metal material, the sheet-metal material consisting of a spring-material alloy which is plated, on at least a top side, with a conductive sheet-metal material made of an electrically conductive conductor material with current-carrying capacity, the at least one solder lug (6) being tin-plated.
